(19) United States
(12) Patent Application Publication
(10) Pub. No.: US 2006/0150801 A1
(43) Pub. Date: Jul. 13, 2006

(54) Constructive device introduced in percussion drum foot pedal for musical instrument

(76) Inventor: Braulio Barrios Veiga, Sao Paulo (BR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/320,604

(22) Filed: Dec. 30, 2005

(30) Foreign Application Priority Data
Jan. 12, 2005 (BR) MU 8500108-2

(51) Int. Cl. G10D 13/02

(52) U.S. Cl. 84/422.1

(57) ABSTRACT

A device (A) on which a pedal (1) is pivotally mounted. The pedal (1) is connected to a cable (2) that passes through a support (3) and is introduced through a flexible conduit (4). The opposite end of the cable (2) is mounted on another support (5) that comprises a device (B). There is a small wheel (6) mounted on a shaft (7) and a beater (8) is mounted on the wheel (6).

### BACKGROUND OF THE INVENTION

1. Field of the Invention

The present invention is directed to a constructive device introduced in the type of foot pedal that is used to produce the percussion of a bass drum.

2. Prior Art

As is general knowledge, the drum kit is a percussion instrument formed by the combination of a series of different drums, such as the bass drum, in addition to cymbals, among other possible accessories.

With specific regard to the bass drum, a foot pedal is normally used, which, through the motion of a pedal mounted on a support, controls the motion of a rod (the beater), which has at its free end a part in direct contact with the bass drum's coating.

Thus, every activation of the foot pedal produces a beating motion between the beater and bass drum.

Due to the manner in which the drums of the drum kit are arranged, the foot pedal and other drum accessories are usually hidden having little visibility, a fact particularly not desirable from the point of view of learning to use the drum kit as a whole, in addition to determining a rigid position for the right foot of the drummer at the drum bass position.

With specific regard to conventional foot pedals, these are difficult to view due to the relative size of the bass drum, which is in fact the largest drum in a drum kit.

### SUMMARY OF THE INVENTION

In view of the above, the present Utility Model patent was designed, which portrays a constructive device introduced in a drum foot pedal for use with a bass drum, which was specially designed to allow the beater (and its supporting and motion structure) to be mounted at the front of the instrument, thus enabling easy viewing of said device's operation. In the device with cables, the pedals are totally free and can be positioned where the drummer deems most convenient, improving ergonomics and comfort.

The Utility Model patent discussed herein shall be described in detail making references to the drawings listed below:

### BRIEF DESCRIPTION OF THE DRAWINGS

FIG. 1 shows a perspective view of a first embodiment of the foot pedal discussed herein;

FIG. 2 shows a perspective view of a second embodiment of the foot pedal object of this Utility Model patent, which differs from the first with respect to the activation and motion mechanisms of the beater;

FIG. 2a schematically illustrates a variant of the type of activation shown in FIG. 2;

FIG. 3 shows a perspective view of a sub-variant of the foot pedal model in FIG. 1, where it is configured according to a concept of independent double activation;

FIG. 4 shows a perspective view of a sub-variant of the foot pedal model in FIG. 2, where it is configured, as can be seen in FIG. 3, according to a concept of independent double activation;

FIG. 5 is a schematic and top view showing the positioning of a bass drum in relation to the foot pedal model in FIG. 1; and

FIG. 6 shows another variant of the foot pedal model discussed herein, where a chain drive system is used.

### DETAILED DESCRIPTION OF THE PREFERRED EMBODIMENTS

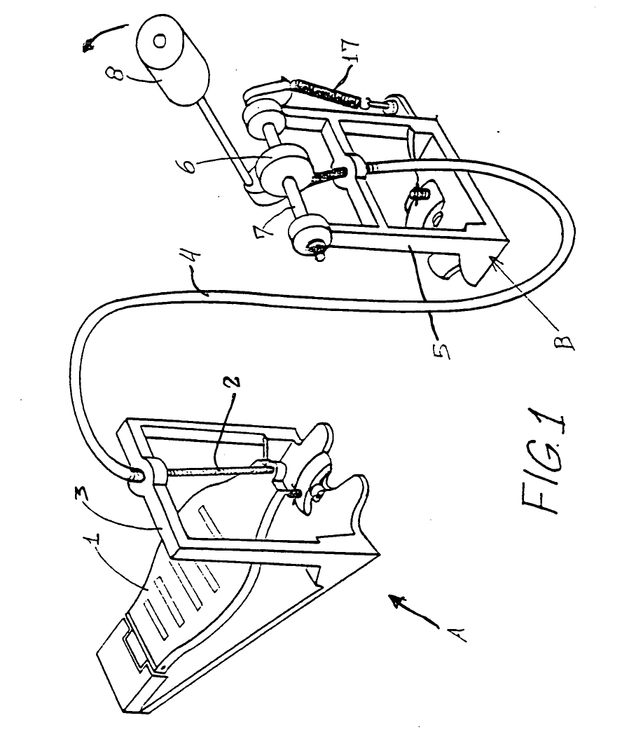

In conformity with the above figures, the foot pedal object of this Utility Model patent comprises, as illustrated in FIG. 1, a first device A, where a first pedal 1 is pivotally mounted.

First pedal 1 is connected to a first cable 2 that passes through a first support 3 and is introduced in a first flexible conduit 4, being that the opposite side of said first cable 2 is mounted in a second support 5 that constitutes a second device B, thus being directly connected to a first small wheel 6 mounted on a first shaft 7, being that a first beater 8 is mounted on said first small wheel 6.

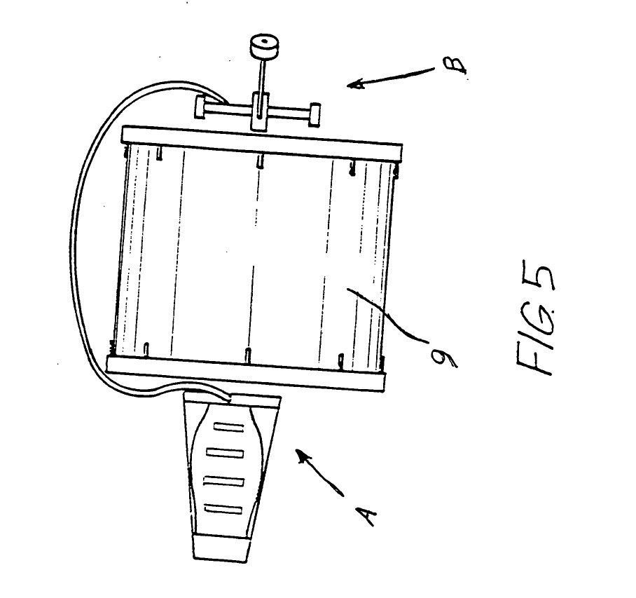

The use of first cable 2 and of first conduit 4 allows spacing of first device A from second device B in such a way that the bass drum 9 can be positioned between them, as is shown in FIG. 5.

Thus, the first beater 8 operates remotely and indirectly through the first foot pedal 1 that comprises the essence of first device A, thus enabling observing bass drum 9 from the front of the drum kit.

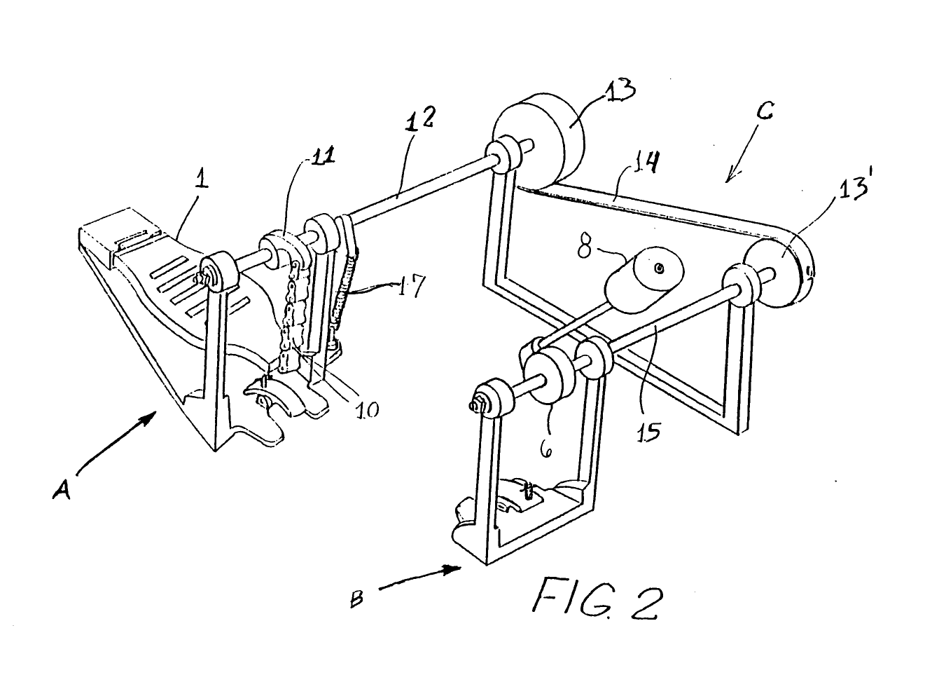

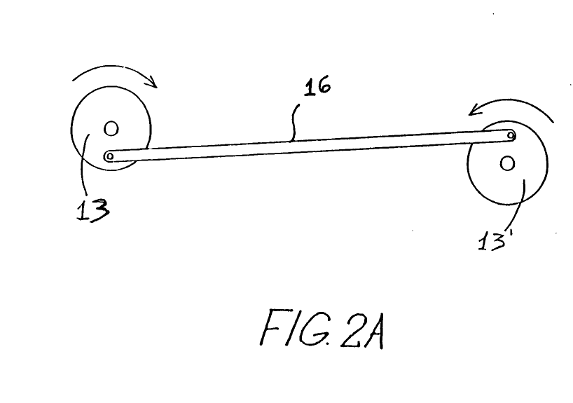

FIG. 2 shows a perspective view of a second embodiment of the foot pedal object of this invention, which differs from the first regarding the activation and motion mechanisms of the first beater 8.

In the embodiment of FIG. 2, the foot pedal (first device A) controls a first chain 10, which by its turn drives a first cam 11 mounted on a horizontal shaft 12 connected to an auxiliary support configuring a third device C, where there are two wheels 13, 13′, one of which (wheel 13) is mechanically connected to said first horizontal shaft 12, being that the wheels 13, 13′ are interconnected by a belt link 14.

The second wheel 13′ is mechanically connected to a second horizontal shaft 15, which is mounted through its right side on second device B, structure in which the first beater 8 is positioned.

Thus, like the model in FIG. 1, activating first pedal 1 of first device A causes the corresponding motion of first beater 8, this assembly having enough space to position (between devices A, B and C) the bass drum 9 of the drum kit.

FIG. 2A schematically illustrates a variant of the type of activation shown in FIG. 2, where belt link 14 is replaced by a rigid rod 16, which has the same basic purposes, that is, transmitting in synchronized fashion the motion between the two wheels 13, 13′.

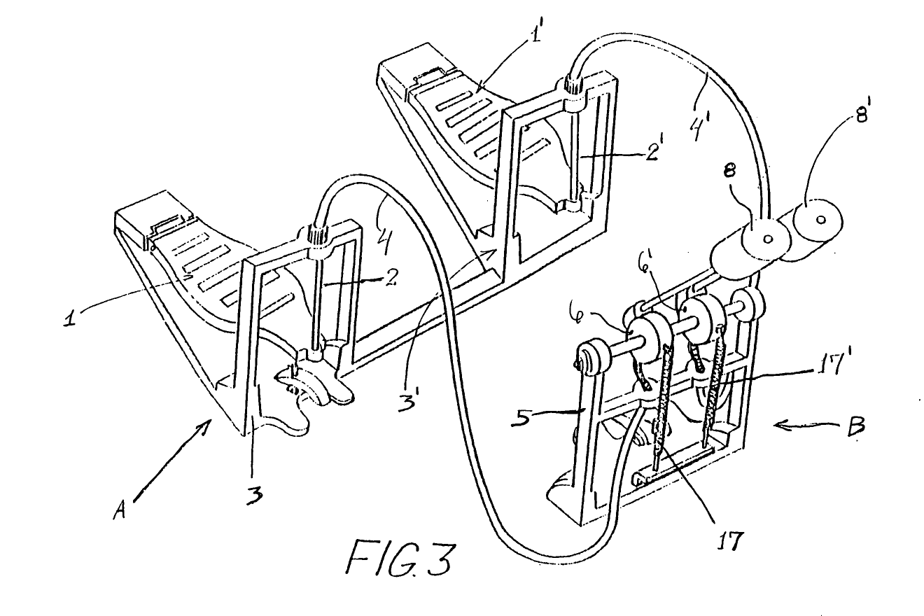

FIG. 3 shows a perspective view of a sub-variant of the foot pedal model in FIG. 1, where it is configured according to a concept of independent double activation, where a device A incorporates two mechanically coupled supports 3, 3′, corresponding pedals 1, 1′ being mounted on each one of the two supports 3, 3′ respectively.

From first device A of FIG. 3 leaves two cable sets 2, 2′ and flexible conduits 4, 4′, connected to a second support 5 comprising a second device B, which conjugate the independent activation of two beaters 8, 8′.

In the same manner as the embodiments in FIGS. 1 and 2, the present embodiment also enables the positioning of a bass drum 9 between devices A and B, such that the operation of beaters 8, 8′ can be seen from the front of said bass drum 9.

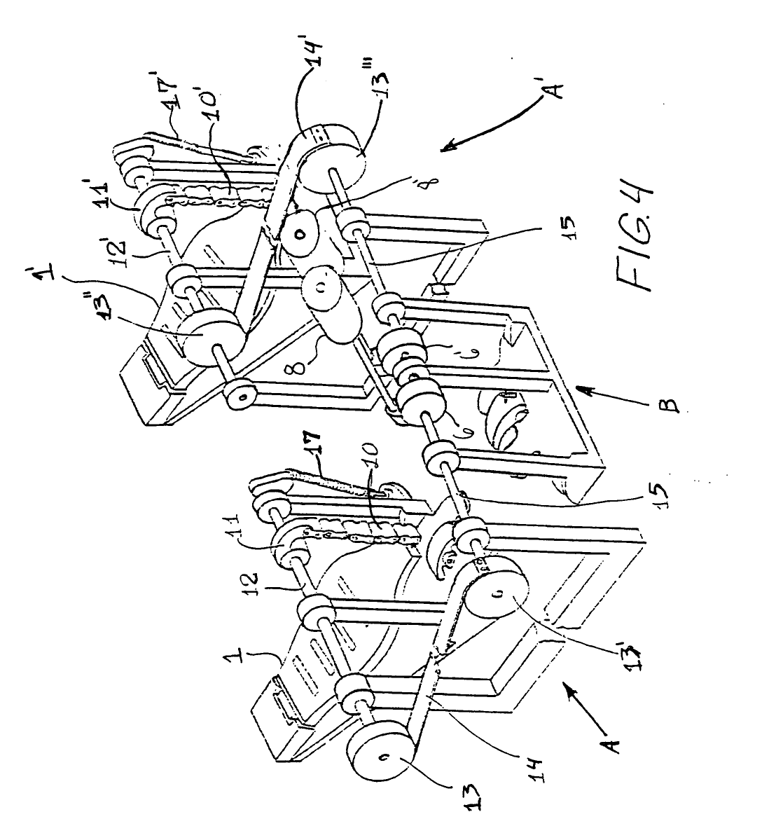

FIG. 4 shows a perspective view of a sub-variant of the foot pedal model in FIG. 2, where it is configured, as can be seen in the embodiment in FIG. 3, according to a concept of independent double activation of its respective beaters 8, 8′.

The embodiment in FIG. 4 has a pair of devices A, A′, each of which has a corresponding pedal 1, 1′, each of which drives a chain 10, 10′ that controls a cam 11, 11′ mechanically mounted on a respective first horizontal shaft 12, and third horizontal shaft 12′.

At the end of each shaft 12, 12′, a wheel 13, 13′ is mounted respectively; the wheels 13 and 13″ being connected to a corresponding second wheel 13′, 13′″ respectively, by means of a pair of belt links 14 and 14′. In each of devices A, A′ of the embodiment shown in FIG. 4, the second wheel 13′, 13′″ is directly connected to a second horizontal shaft 15, that passes through second device B, where the beaters 8, 8′ are mounted.

In the same manner as the already described embodiments, the bass drum 9 of the model in FIG. 4 can be mounted between devices A, B and C.

In all the embodiments portrayed in the present invention, the motion of beaters 8, 8′ occurs against the action of a return spring 17, 17′, which can either be incorporated to second device B (in the case of the embodiments in FIGS. 1 and 3) or to first device A (in the case of the embodiments in FIGS. 2 and 4).

The general positioning of the present device (in any of its various embodiments) with relation to the musical instrument so to speak, that is, with relation to the bass drum 9, can be seen in FIG. 5.

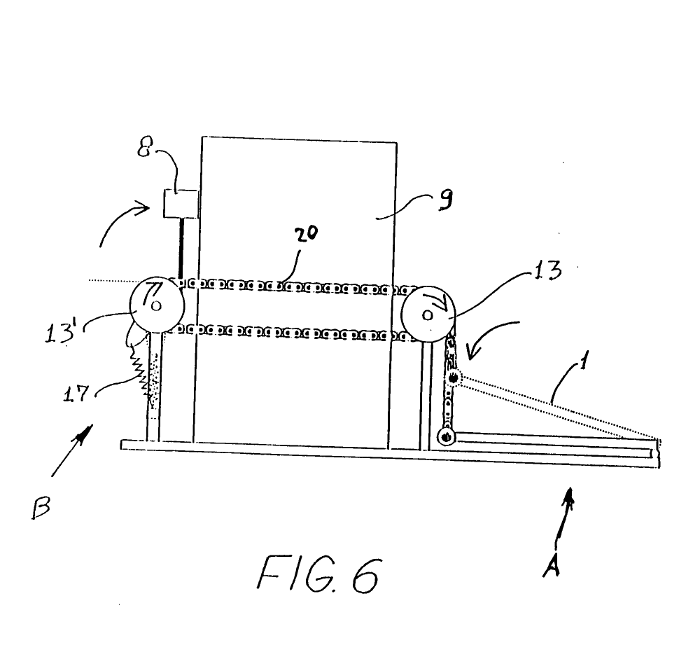

FIG. 6 shows a side view of another variant of the device discussed herein, which includes the use of a chain 20 to mechanically connect the two wheels 13, 13′, which are obviously adapted for this type of drive. Generally, the same type of positioning with relation to bass drum 9 occurs in the variant shown in FIG. 6.

What is claimed is:

1. A constructive device for use in a percussion drum foot pedal of a musical instrument comprising:
a first device (A) on which a first pedal (1) is pivotally mounted, said first pedal (1) being connected to an end of a first cable (2), said first cable (2) passing through a first support (3) and being introduced through a first flexible conduit (4); and,
an opposite end of said first cable (2) being mounted on a second support (5) comprising a second device (B), said second device (B) including a first small wheel (6) mounted on a first shaft (7), said first small wheel (6) including a first beater (8) whereby when said first foot pedal (1) is pivotally actuated said first beater (8) is displaced.

2. The constructive device for use in a percussion drum foot pedal of a musical instrument, as recited in claim 1, further comprising:
a second support (3′) forming a portion of first device (A), said first and second supports (3, 3′) being coupled each to the other, each of said first and second supports (3, 3′) being mounted to a corresponding pedal (1, 1′);
a second cable (2′) having a first end connected to said second support (3′); and
a second flexible conduit (4′), wherein second ends of said first and second cables (2, 2′) and said first and second flexible conduits (4, 4′) are connected to said second device (B) thereby activating said first and a second beater (8, 8′) on said second device (B).

3. A constructive device for use in a percussion drum foot pedal of a musical instrument comprising:
a first device (A) on which a first pedal (1) is pivotally mounted, said first pedal (1) being connected to a first chain (10), said first chain (10) driving a first cam (11) mounted on a first horizontal shaft (12), said first horizontal shaft (12) coupled to an auxiliary support defining a third device (C) including a first pair of wheels (13, 13′), each of first pair of wheels (13, 13′) being coupled each to the other by a coupling link, a respective one of said pair of wheels (13′) being coupled to a first end of a second horizontal shaft (15) and,
a second device (B) having said second horizontal shaft (15) mounted thereon, said second device (B) including a first small wheel (6) mounted on said second horizontal shaft (15), said first small wheel (6) including a first beater (8) whereby when said first pedal (1) is pivotally actuated said first beater (8) is displaced.

4. The constructive device for use in a percussion drum foot pedal of a musical instrument, as recited in claim 3, wherein said coupling link is a belt link (14) which is coupled to each of said wheels (13, 13′).

5. The constructive device for use in a percussion drum foot pedal of a musical instrument, as recited in claim 3, wherein said coupling link is a rigid rod (16) coupled on opposing ends to said pair of wheels (13, 13′).

6. The constructive device for use in a percussion drum foot pedal of a musical instrument as recited in claim 3, further comprising a fourth device (A′) on which a second pedal (1′) is pivotally mounted, said second pedal (1′) being connected to a second chain (10′), said second chain (10′) driving a second cam (11′) mounted on a third horizontal shaft (12′), said fourth device (A′) having a second pair of wheels (13″, 13′″), a respective one of said wheels (13″) being located at an end of said third horizontal shaft (12′) each of said wheels (13″, 13′″) being coupled each to the other by a coupling link, another one of said respective wheels (13′″) being coupled to an opposite end of said second horizontal shaft (15), said second device (B) including a second small wheel (6′) mounted on said second horizontal shaft (15), said second small wheel (6′) including a second beater (8′) whereby when said second pedal (1′) is pivotally actuated said second beater (8′) is displaced.

7. The constructive device for use in a percussion drum foot pedal of a musical instrument, as recited in claim 1, wherein said wheels (13, 13′) are coupled each to the other by an endless chain (20).

8. A constructive device introduced in a drum foot pedal for musical instrument characterized by the fact that it has a device (A) on which a pedal (1) is pivotally mounted; the pedal (1) being connected to a cable (2) that passes through a support (3) and is introduced through a flexible conduit (4), being that the opposite end of said cable (2) is mounted on another support (5) comprising a device (B), thus directly connected to a small wheel (6) mounted on a shaft (7), being that the beater (8) is mounted on said wheel (6); in a second embodiment of the foot pedal, the device (A) controls a chain (10), which by its turn drives a cam (11) mounted on a horizontal shaft (12) connected to an auxiliary support that configures a device (C), where two small wheels (13) are arranged, one of which is mechanically connected to said horizontal shaft (12), being that the wheels (13) are interconnected by a belt link (14), the second wheel (13) is mechanically connected to another horizontal shaft (15), which is mounted at the opposite end on device (B), structure in which the beater (8) is positioned; in another variant, the belt link (14) is replaced by a rigid rod (16), which operates with the same basic purpose of transmitting in synchronized fashion the motion between the two wheels (13); in another variant, the device (A) incorporates two mechanically coupled supports (3), where each of the two supports (3) is mounted on a corresponding pedal (1); from the support (A) leaves two cable sets (2) and a flexible conduit (4), conducted to the support (5) comprising the device (B) which conjugates the independent activation of two beaters (8); in another variant, the present foot pedal has independent double activation of its respective beaters (8), a pair of devices (A) being provided, each of which has a corresponding pedal (1), each of which drives a chain (10) that controls a cam (11) mechanically mounted on a horizontal shaft (12); at the end of each shaft (12), a small wheel is mounted (13), connected to a corresponding second wheel (13) by means of a belt link (14), being that in each of the devices (A), the second wheel (13) is directly connected to a second horizontal shaft (15) that passes through device (B), where the beaters (8) are mounted; in another embodiment, the foot pedal in question uses a chain to mechanically connect the two wheels (13).
